(19) United States
(12) Patent Application Publication
(10) Pub. No.: US 2023/0270172 A1
(43) Pub. Date: Aug. 31, 2023

(54) Aerosol Generation Device

(71) Applicant: JT International SA, Geneva (CH)

(72) Inventors: Andrew Robert John ROGAN, Forres (GB); Alec WRIGHT, Guildford (GB)

(73) Assignee: JT International SA, Geneva (CH)

(21) Appl. No.: 18/005,774

(22) PCT Filed: Jul. 16, 2021
(86) PCT No.: PCT/EP2021/069992

§ 371 Date: Jan. 17, 2023

(30) Foreign Application Priority Data
Jul. 17, 2020 (EP) 20186584.7

(51) Int. Cl. A24F 40/485; A24F 40/20; A24F 40/46; A24F 40/50; H05B 3/42

(52) U.S. Cl. CPC A24F 40/485; A24F 40/20; A24F 40/46; A24F 40/50; H05B 3/42

(57) ABSTRACT

An aerosol generation device includes a chamber with an opening for receiving an aerosol generation medium, a heating element configured to heat the aerosol generation medium, and a moveable base configured to move along a length of the chamber. The moveable base comprises one or more channels configured to allow an airflow through the moveable base. The moveable base divides the chamber to define a first region toward the opening, and a second region away from the opening. One or more air inlets are arranged in the second region of the chamber and configured to provide an air flow path from outside the device into the second region by one or more air inlet channels connecting one or more air inlet openings adjacent to the opening of the chamber to the one or more air inlets in the second region of the chamber.

### FIELD OF INVENTION

The present invention relates to aerosol generation devices.

### BACKGROUND

Aerosol generation devices, such as electronic cigarettes, are becoming increasingly popular consumer products.

Heating devices for aerosolisation, or vaporisation, are known in the art. Such devices typically include a heater arranged to heat an aerosol generating product. In operation, the aerosol generating product is heated with the heater to aerosolise the constituents of the product for the consumer to inhale. Such devices are typically designed to heat the aerosol generating product without burning it. Aerosol generating products may comprise tobacco in a form similar to a traditional cigarette, or in a capsule; other aerosol generating products may be a liquid, or liquid contents in a capsule.

There is a need to improve the experience of the consumer of such products; an object of the present invention is to address this need by improving the airflow in such aerosol generation devices.

### SUMMARY

According to a first aspect, there is provided an aerosol generation device comprising: a chamber with an opening for receiving an aerosol generation medium; a heating element configured to heat the aerosol generation medium when the aerosol generation medium is received in the chamber; and a moveable base configured to move along a length of the chamber, wherein the moveable base comprises one or more channels configured to allow an airflow through the moveable base.

In this way the moveable base can securely hold aerosol generation mediums of different lengths within the chamber, and provide an airflow to the aerosol generation medium through the one or more channels. This airflow path provides an improved control of the airflow into the aerosol generation medium and accommodates the pressure drop brought about when the user inhales upon the aerosol generation device. This improves the user experience.

Optionally, the moveable base divides the chamber to define a first region toward the opening, and a second region away from the opening.

Optionally, one or more air inlets are arranged in the second region of the chamber, the one or more air inlets configured to provide an air flow path from outside the device into the second region.

In this way, air that is external to the aerosol generation device can be drawn into the second region of the chamber, and pre-heated, when a user of the aerosol generation device draws or inhales upon the aerosol generation medium.

Optionally, the one or more air inlets are arranged in the second region of the chamber and are configured provide an air flow path from outside the device into the second region by one or more air inlet channels connecting one or more air inlet openings adjacent to the opening of the chamber to the one or more air inlets in the second region of the chamber.

Optionally, the one or more air inlet channels run alongside the chamber to feed air into the second region of the chamber.

In this way, residual heat from the chamber contributes to pre-heating the air flow by heating the air in the channels running alongside the chamber Optionally, the heating element extends into the chamber in a direction toward the opening.

In this way, the heating element engages the aerosol generation medium so as to effectively heat the aerosol generation medium to generate an aerosol.

Optionally, the first region is configured to heat the aerosol generation medium, and the second region is configured to pre-heat an airflow to the aerosol generation medium.

In this way, the pre-heating of the airflow in the second region of the chamber can improve the user experience by mixing pre-heated air with the aerosol generated in the first region of the chamber. This can create a more consistent temperature for the aerosol product. Furthermore, pre-heating the air before it is drawn into the aerosol generation medium inhibits the intake of ambient (or cold) air affecting the heating of the aerosol generation medium. Such cold air can lower the temperature in the aerosol generation medium, thereby requiring more power to be supplied to the heating element for the aerosolisation of the aerosol generation medium. By pre-heating the air, less power needs to be supplied to the portion of the heating element used for the aerosolisation as the pre-heated air reduces or inhibits the effect of a temperature drop in the aerosol generation medium.

Optionally, the moveable base is configured to move along the heating element such that a first portion of the heating element is arranged in the first region of the chamber and a second portion of the heating element is arranged in the second region of the chamber.

In this way, a single heating element can have a first portion in the first region of the chamber to aerosolise the aerosol generation medium and a second portion in the second region of the chamber to pre-heat the airflow to the aerosol generation medium. The portion of the heating element that is in the second region of the chamber is not engaging the aerosol generation medium, but can heat the air in the second region which is then drawn into the aerosol generation medium through the channels in the moveable base. This arrangement inhibits the wastage of heat generated in the second portion of the heating element.

Optionally, the heating element comprises a plurality of heating zones, each configured to be separately heated based upon a determined heating profile; and wherein the aerosol generation device further comprises a controller configured to determine a position of the moveable base along the heating element, wherein the heating profile is determined based upon the determined position of the moveable base such that a first set of heating zones of the plurality of heating zones arranged in the first region of the chamber operate at a first temperature, and wherein a second set of heating zones of the plurality of heating zones arranged in the second region of the chamber operate at a second temperature different to the first temperature.

In this way, different temperatures can be applied in the pre-heating region and the heating region. This can improve the user experience by allowing for the setting of desirable pre-heating and heating (or aerosolisation) temperatures.

Optionally, the moveable base is moveable between an extended position at a first distance from the opening, and a retracted position at a second distance from the opening, the second distance being greater than the first distance.

In this way, aerosol generation mediums of different lengths can be received in the chamber.

Optionally, the heating element passes through an opening in the moveable base.

Optionally, the moveable base has a first surface facing toward the opening, and a second surface, opposite the first surface, facing away from the opening, and wherein the one or more channels pass through the moveable base to connect the first surface to the second surface.

Optionally, the heating element is a heating blade insertable into the aerosol generation medium when received in the chamber.

In this way, the heating blade can efficiently aerosolise the aerosol generation medium.

Optionally, the heating blade comprises a piercing end directed toward the opening of the chamber.

In this way, the heating blade can be efficiently brought into connection with the aerosol generation medium.

Optionally, the heating element is configured the heat the aerosol generation medium without burning the aerosol generation medium.

In this way, an aerosol is generated whilst inhibiting the generation of smoke.

According to a second aspect, there is provided an aerosol generation system comprising the aerosol generation device of the first aspect with the aerosol generation medium received in the chamber.

Optionally, for the aerosol generation device of the first aspect, or the aerosol generation system of the second aspect, the aerosol generation medium is a tobacco rod.

### BRIEF DESCRIPTION OF THE DRAWINGS

Embodiments of the invention are now described, by way of example, with reference to the drawings, in which:

FIG. 1A is a cutaway diagram of an aerosol generation device;

FIG. 1B is a cutaway diagram of the aerosol generation device with an aerosol generation medium received therein;

FIG. 2 is a plan view of a moveable base of the aerosol generation device;

FIG. 3 is enhanced cutaway diagram of the chamber region of the aerosol generation device; and

FIG. 4 is a cutaway diagram of a heating element and moveable base.

### DETAILED DESCRIPTION

An aerosol generation device 100 is a device arranged to heat an aerosol generation medium 140 to produce an aerosol for inhalation by a consumer. In a specific example, an aerosol generation medium 140 can be a tobacco rod similar to a traditional cigarette. That is, tobacco fibres wrapped in paper. An aerosol generation device 100 can also be considered an electronic cigarette, or a vapour generation device. In context of the present disclosure, the terms vapour and aerosol can be used interchangeably. In some examples, aerosol generation medium 140 can be a liquid or a solid such as a fibrous material, or a combination thereof, that when heated generates a vapour or aerosol.

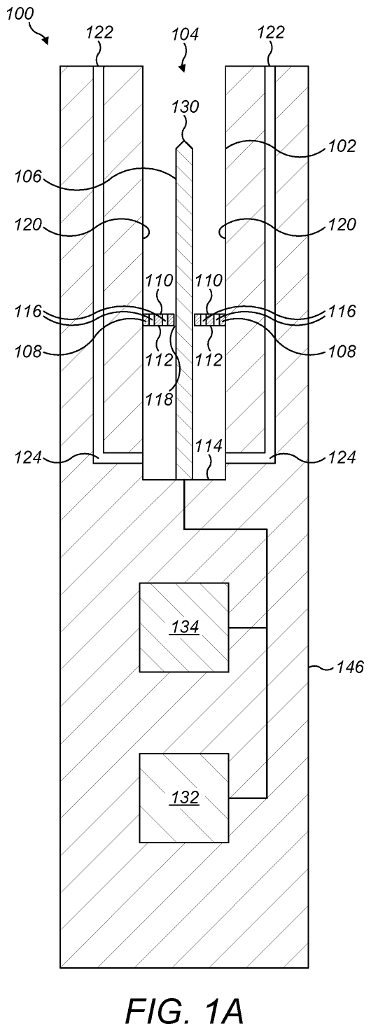

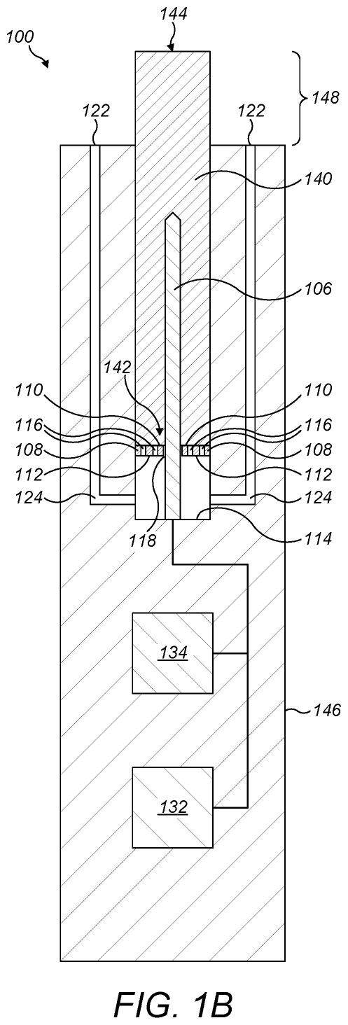

FIG. 1A shows a cutaway diagram of presenting a cross-section of an aerosol generation device 100.

The aerosol generation device 100 is configured to receive an aerosol generation medium 140, as in FIG. 1B which shows a cutaway diagram of presenting a cross-section of an aerosol generation device 100 with an aerosol generation medium 140 received therein. The aerosol generation medium 140 can comprise an aerosol generating material. The aerosol generation medium 140 can be a cigarette-like consumable, also referred to as a tobacco rod, and the aerosol generating material can be tobacco. The aerosol generation device 100 is configured to heat the aerosol generation medium 140 to generate an aerosol without burning the aerosol generation medium 140. Such a device can be considered ‘heat-not-burn’ device, which heats the tobacco to generate an aerosol, without burning the tobacco.

Whilst the following description refers to the aerosol generation medium 140 as a tobacco rod, any other suitable type of aerosol generation medium 140 may be used as an alternative. For example, a cartridge comprising a liquid and/or solid aerosol generating material may be used as an alternative.

The aerosol generation device 100 has a body 146 in which a chamber 102 is arranged. An opening 104 in the body 146 provides access to the chamber 102.

The chamber 102 is configured to receive the tobacco rod 140 through the opening 104. The chamber 102 can have a cross-sectional size and shape defined by internal walls 120 of the chamber 102 corresponding to the size and shape of the tobacco rod 140 such that the tobacco rod 140 securely fits within the chamber 102 and is held in place by the internal walls 120. In an example the chamber 102 is substantially cylindrical in shape.

A heating element 106 is positioned within the chamber 102 and configured to heat the tobacco rod 140 when received in the chamber 102. In the example of FIGS. 1A and 1B, the heating element 106 is a heating blade that extends inwardly to the chamber 102 from the bottom 114 of the chamber 102. Such a heating blade 106 can be elongate in the axial direction of the chamber 102, and planar in a radial direction of the chamber 102, with a pointed piercing end 130 at an end nearest to the opening 104. The bottom 114 of the chamber 102 can be considered an end of the chamber 102 opposite to the opening 104. The heating element 106 extends from the bottom 114 of the chamber 102 toward the opening 104 of the chamber 102. The heating element 106 can extend fully along the axial length of the chamber 102, or through a substantial portion of the axial length of the chamber 102. The heating element 106 is positioned substantially centrally within the chamber 102 and is dimensioned so as to fit into the tobacco rod 140. When inserted into the chamber 102, a first end 142 of the tobacco rod 140 is pierced by the heating element 106; as the tobacco rod 140 is pushed further into the chamber 102, the heating element 106 engages the tobacco rod 140 by sliding through an axial length of the tobacco rod 140.

In alternatives, the heating element 106 may instead be integrated into or mounted onto the internal walls 120 of the chamber 102 so as to surround the tobacco rod 140. In such an alternative, the heating element 106 can be a coil heater.

The heating element 106 is coupled to a power supply 132, such as a battery, and a controller 134 that operably controls the aerosol generation device 100. The battery 132 and controller 134 can be housed within the body 146 of the aerosol generation device 100. The controller 134 detects when a heater ignition button (not shown) is pressed and controls a power flow from the battery to the heating element 106 so as to heat the heating element 106 for an aerosolisation session. The controller 134 can be a microcontroller unit and can comprise one or more processors and memory storing instructions that are executable by the one or more processors to control the operation of the aerosol generation device 100.

A tobacco rod 140 that can be inserted into the chamber 102 has a mouthpiece portion 148 at a second end 144 opposite to the first end 142. In some examples, the mouthpiece portion 148 includes a filter plug. The tobacco rod 140 is composed of the mouthpiece portion 148 adjoining to an aerosolisable portion comprising the aerosolisable material (for example, a tobacco portion comprising tobacco fibres). When received in the chamber 102 the aerosolisable portion is contained within the chamber 102, and the mouthpiece portion 148 of the tobacco rod 140 extends outwardly from the opening 104. In this way, the user of the aerosol generation device 100 can inhale upon the mouthpiece portion 148, during an aerosolisation session, when tobacco rod 140 is inserted into the chamber 102.

One or more air inlets 122 are arranged in the body 146 of the aerosol generation device 100, and are connected by air inlet channels 124 to the chamber 102. When the user of the aerosol generation device 100 inhales upon the tobacco rod 140 the pressure within the chamber 102 drops and air is drawn into the chamber 102, from outside the device, through the air inlet channels 124. The air inlet channels 124 are arranged to feed the air into the chamber 102 substantially toward the bottom 114 of the chamber 102, or at the bottom 114 of the chamber 102. In some examples, the openings for the air inlets 122 may be arranged adjacent to the opening 104 of the chamber 102 in an end surface of the body 146 of the aerosol generation device 100. In such an example the air inlet channels 124 can run alongside the length of the chamber 102 to feed air into the bottom of the chamber 102; this can be considered an inlet counter-flow as the airflow into the chamber moves substantially in the opposite direction to the airflow moving through the chamber 102 and tobacco rod 140 toward the opening 104. Arranging the openings for the air inlets 122 adjacent to the opening 104 of the chamber 102 inhibits the operator inadvertently blocking the openings of the air inlets 122 with their hand when holding the aerosol generation device 100. Residual heat from the chamber 102 can also warm the airflow as it passes through the channels 124 alongside the chamber 102. In other examples, the openings for the air inlets 122 may be arranged in a sidewall of the body 146 at a location proximal to the bottom of the chamber 102 to provide the shortest airflow path, in the airflow channels 124, into the chamber 102.

A moveable base 108 is positioned within the chamber 102. The moveable base 108 is configured to move along the length of the chamber 102, in the axial direction of the chamber 102 (that is, the direction toward and away from the opening 104 of the chamber 102 along the length of the chamber 102). The moveable base 108 can be attached to a guiding track along which guides the movement of the moveable base 108 through the chamber 102. The moveable base 108 is a platform against which the first end 142 of the tobacco rod 140 presses when the tobacco rod 140 is inserted into the chamber 102. The moveable base 108 has a cross-sectional shape and size dimensioned approximately equal to that of the chamber 102, and a thickness dimension considerably less than the depth of the chamber 102. In an example, the moveable base 108 may have a thickness of 2 to 10 mm and the chamber 102 may have a depth of 10 to 50 mm.

In some examples the moveable base 108 may be resiliently biased, such as by a spring, to a first position, or extended position, within the chamber 102 (FIG. 1A). The first position can be substantially central to the length of the chamber 102, or toward the opening 104. When the tobacco rod 140 is pushed into the chamber 102, it presses against the moveable base 108 and the moveable base 108 moves downward in the chamber 102, away from the opening 104, against the resiliently biasing force. A frictional force between the tobacco rod 140 and the internal walls 120 of the chamber 102 overcomes the resilient biasing force so as to hold the tobacco rod 140 in place with the moveable base 108 in a second position, or retracted position, that is closer to the bottom 114 of the chamber 102 (FIG. 1B). That is, the moveable base 108 is moveable between an extended position at a first distance from the opening 104, and a retracted position at a second distance from the opening 104, the second distance being greater than the first distance. Tobacco rods of different lengths may be inserted into the chamber 102; if the tobacco rod 140 is of a short length, comparable to or less than the depth of the chamber 102, it would be unfavourable for the tobacco to drop into the chamber 102 to an extent that the mouthpiece portion 148 no longer extends sufficiently outwardly from the chamber 102. The resilient biasing force applied to the moveable base 108 inhibits the tobacco rod 140 from slipping further into the chamber 102 than desired. In this way, the moveable base 108 secures the tobacco rod 140 at an operable position within the chamber 102 such that the mouthpiece portion 148 of the tobacco rod 140 extends from the chamber 102.

Alternatively, or additionally, in other examples the position of the moveable base 108 can be manually controlled by the user of the aerosol generation device 100 between the first position (FIG. 1A) and the second position (FIG. 1B). For example, the moveable base 108 can be connected to an electric motor or solenoid that drives the moveable base 108 in directions toward and away from the opening 104. The electric motor or solenoid can be controlled by the controller 134 of the aerosol generation device 100 to move along the length of the chamber 102 in response to a user of the device selecting an input configured to instruct the controller 134 to move the moveable base 108. In another example, the moveable base 108 can be manually moved by a user of the aerosol generation device 100 in a mechanical manner. A through-pin arranged in a slot or threaded grove can connect the moveable base 108 to a handle on the exterior of the aerosol generation device 100 which when moved by the user in a sliding or rotating manner mechanically causes the moveable base 108 to move along the length of the chamber 102. Advantageously, these means for adjusting the position of the moveable base 108 allow for a user of the aerosol generation device 100 to adjust the depth of the chamber 102 so that tobacco rods of different lengths can be received within the chamber 102, whilst ensuring that the mouthpiece portion 148 of the tobacco rod 140 still extends from the chamber 102 for the user to inhale upon.

The moveable base 108 can be disc-like in form. The moveable base 108 has a first surface 110 that faces toward to the opening 104 of the chamber 102, and a second surface 112 on an opposite side of the moveable base 108 to the first surface 110 that faces toward the bottom 114 of the chamber 102.

A slot 118 is arranged in the moveable base 108 through which the heating element 106 passes. In this way, the moveable base 108 can move along the length of the heating element 106 when moving in the chamber 102.

One or more holes 116 are arranged in the moveable base 108. These holes 116 are through-holes forming channels 116 that connect the first surface 110 of the moveable base 108 to the second surface 112 so as to allow an airflow to pass through the moveable base 108. The through-holes 116 extend through the moveable base 108 in the direction of the axial length of the chamber 102, that is the direction in which the tobacco rod 140 is inserted into the chamber 102.

The through-holes 116 provide an airflow path from the air inlets 122 to the tobacco rod 140. In use, when a user of the aerosol generation device 100 inhales upon the mouthpiece portion 148 of the tobacco rod 140, air is drawn into and through the tobacco rod 140, through the through-holes 112 in the moveable base 108, creating a pressure drop in the chamber 102. Air is drawn into the chamber 102 from the air inlets 122, through the air inlet channels 124, to balance this pressure drop. As the user continues to inhale, the airflow moves through the through-holes 116 or channels in the moveable base 108 and into the first end 142 of the tobacco rod 140. The airflow interacts with the aerosol generated in the tobacco rod 140 to form the aerosol product which is drawn through the mouthpiece portion 148 when the user inhales. That is, the through-holes 116 in the moveable base 108 contribute to an airflow path from the air inlets 122, through the air inlet channels 124, into the chamber 102, through the through-holes 116 in the moveable base 108, into the first end 142 of the tobacco rod 140, through the aerosolisable portion of the tobacco rod 140 and the mouthpiece portion 148 of the tobacco rod 140 and out of the second end 144 of the tobacco rod 140.

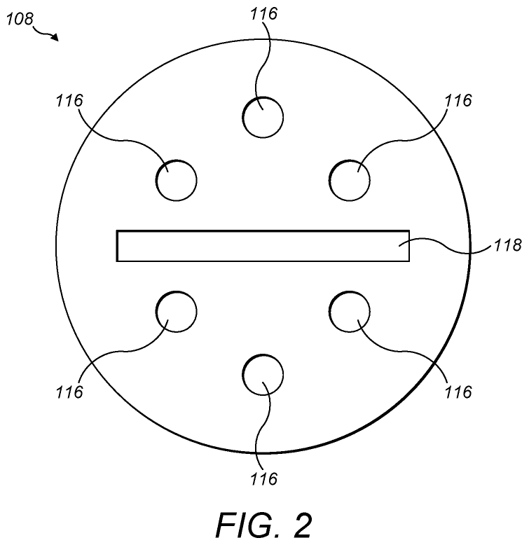

FIG. 2 shows a plan view of the moveable base 108. In the example of FIG. 2, six through-holes 116 are distributed around the slot 118 through which the heating element 106 passes. The slot 118 for the heating element 106 is positioned centrally to the moveable base 108 to correspond to the central position of the heating element 106 within the chamber 102. It will be understood that six through-holes 116 are only presented for exemplary purposes, and the moveable base 108 can comprise any suitable number of through-holes 116. The through-holes 116 need not be distributed around the slot 118 in the arrangement depicted in FIG. 2, and can instead be distributed in any suitable arrangement in the moveable base 108. The maximum limit to the number of through-holes 116 can be at the point at which any further through-holes 116 would be unfavourable due to a weakening in the structural integrity of the moveable base 108. It is preferable to have as many through-holes 116 as possible, to allow for an even airflow into the tobacco rod 140, without substantially weakening the structural integrity of the moveable base 108.

Preferably, the through-holes 116 are substantially evenly and/or symmetrically distributed in the moveable base 108 so as to provide an even airflow into the tobacco rod 140.

The slot 118 can be dimensioned to have a similar cross-sectional shape to the cross-section of the heating element 106, only slightly larger so that the heating element 106 can pass through the slot 118 in an uninhibited manner. The gap between the heating element 106 and the edge of the slot 118 can allow a further airflow channel through the moveable base 108, in addition to the through-holes 116. Alternatively, the slot 118 can be dimensioned so that the heating element 106 fits therethrough so that there is a snug fit between the heating element 106 and the moveable base 108.

In an example, the through-holes 116 can have diameters in the range of 0.1 to 3.0 mm. It is preferable that the through-holes 116 are as large as possible, to allow for an even airflow into the tobacco rod, without weakening the structural integrity of the moveable base 108.

The moveable base 108 can be of a material that is resistant to deformation when heat is applied so as to inhibit the moveable base 108 deforming when the heating element 106 heats the tobacco rod 140. Such materials can include, for example, metals, plastics and ceramics. It is also preferable for the moveable base 108 to be formed of a thermally conductive material so as to aid the spread of heat across end of the tobacco rod 140 abutting the moveable base 108; this can contribute to warming the airflow into the tobacco rod 140. An example of such a material is aluminium.

As previously described, in some examples the heating element 106 can be arranged in or on the internal wall 120 of the chamber 102. In such examples, when there is no heating element 106 central to the chamber 102, the moveable base 108 need not have a slot 118 for the heating element 106.

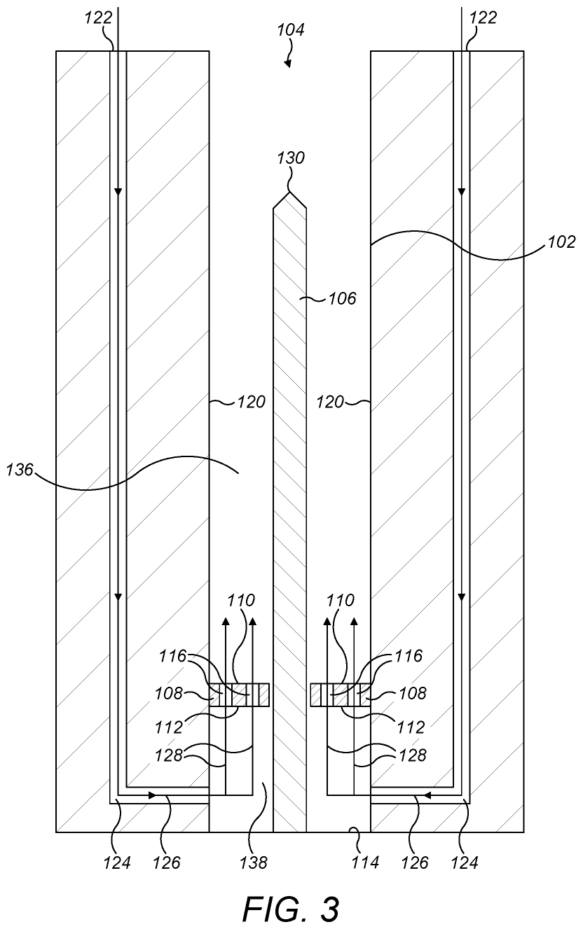

FIG. 3 shows an enhanced cutaway diagram of the chamber 102 region of the aerosol generation device 100, for clarity a tobacco rod 140 is not shown.

The axial displacement of the moveable base 108 from the opening 104 and the bottom 114 of the chamber 102 causes the moveable base 108 to bifurcate the chamber 102 into two regions, a first chamber region 136 toward the opening 104 and a second chamber region 138 toward the bottom 114 of the chamber 102. That is, the moveable base 108 divides the chamber 102 so as to have a first region 136 toward the opening 104 and a second region 138 away from the opening 104. The first 136 and second 138 regions of the chamber 102 are separated by the moveable base 108. The first surface 110 of the moveable base 108 faces the first region 136 of the chamber 102, and the second surface 112 of the moveable base 108 faces the second region 138 of the chamber 102.

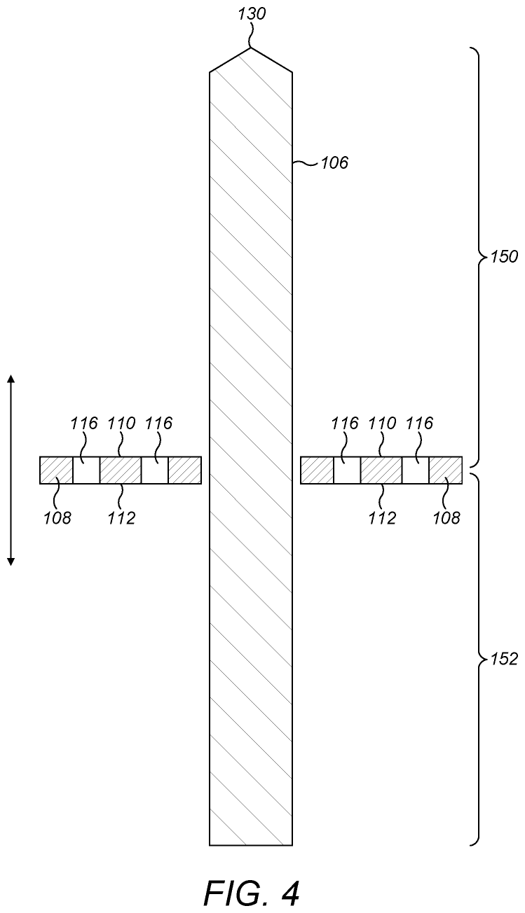

As the heating element 106 extends along axial length of the chamber 102, through the moveable base 108, the heating element 106 is also divided into two portions by the moveable base 108. A first portion 150 of the heating element 106 is arranged within the first region 136 of the chamber 102, and a second portion 152 of the heating element 106 is arranged the second region 138 of the chamber 102. This division of the heating element 106 into two portions is presented in FIG. 4 which shows a cutaway diagram of the moveable base 108 dividing the heating element 106 along the axial direction into a first portion 150 and a second portion 152.

When the moveable base 108 moves, the length of the heating element 106 forming the first portion 150 and the length forming the second portion 152 changes. Likewise, when the moveable base 108 moves, the volume of the chamber 102 forming the first region 136 and the volume forming the second region 138 changes.

As described, the moveable base 108 is either pushed toward the bottom 114 of the chamber 102 by the tobacco rod 140, or moved toward the bottom 114 of the chamber 102 so as to accommodate the tobacco rod 140. In either case, the moveable base 108 does not move fully to the bottom 114 of the chamber 102 (as shown in FIG. 1B), and as such the second region 138 of the chamber 102 can still be present when the tobacco rod 140 is received in the chamber 102.

When inserted into the chamber 102, the tobacco rod 140 is positioned only in the first region 136 of the chamber 102 and not the second region 138. The first portion 150 of the heating element is inserted into the tobacco rod 140 so as to aerosolise the tobacco portion of the tobacco rod 140. The second portion 152 of the heating element 106 does not engage the tobacco rod 140. In effect, the second region 138 of the chamber 102 is empty as the tobacco rod 140 is not received in this region, and the second portion 152 of the heating element 106 is not directly heating the tobacco rod 140.

The air inlet channels 124 are arranged toward or at the bottom 114 of the chamber 102 so as to be positioned in the second region 138 of the chamber 102. The air inlet channels 124 feed the air from the air inlets 122 into the second region 138 of the chamber 102. When the heating element 106 is triggered so as to heat the tobacco rod 140, the first portion 150 of the heating element 106 heats the tobacco rod 140 and the second portion 152 of the heating element 106 heats the air in the second region 138 of the chamber 102. That is, as ambient air 126 (air at a temperature external to the device) is drawn into the second region 138 of the chamber 102, it is heated by the second portion 152 of the heating element 106 to form pre-heated air 128 before being drawn through the through-holes 116 in the moveable base 108. This heating of the ambient air 126 in the second region 138 of chamber 102 forms a pre-heated airflow 128 to the tobacco rod 140. As such, the second region 138 of the chamber 102 can be considered a pre-heating region as it pre-heats the airflow, and the first region 136 of the chamber 102 can be considered a heating region as it heats (and aerosolises) the aerosol generating material.

In this way, heat generated in the portion of the heating element 106 that does not engage the tobacco rod 140 is not wasted. This is particularly beneficial for tobacco rods of a shorter length; as a greater portion of the heating element 106 does not engage such short tobacco rods, a greater portion of heat would be wasted. The pre-heating region 138 realised by the moveable base 108 and through-holes 116 allows for this otherwise wasted heat to be utilised for pre-heating the airflow rather than being wasted.

The pre-heating of the air in the second region 138 of the chamber 102 can improve the user experience by mixing pre-heated air with the aerosol generated by aerosolising the aerosol generating material in the tobacco rod 140. This can create a more consistent temperature for the aerosol product. Furthermore, pre-heating the air before it is drawn into the tobacco rod 140 inhibits the intake of ambient (or cold) air 126 affecting the heating of the tobacco rod 140 by the first portion 150 of the heating element 106. Such cold air 126 can lower the temperature in the tobacco rod 140, thereby requiring more power to be supplied to the heating element 106. By pre-heating the air 128, less power needs to be supplied to the heating element 106 for the aerosolisation as the pre-heated air reduces or inhibits the effect of a temperature drop in the tobacco rod 140.

In the aforementioned arrangement, the same power is applied to heat both portions of the heating element 106. In a modified arrangement, the heating element 106 can be divided into a plurality heating zones which can be separately and differently powered and therefore heated to different temperatures. The heating zones may be formed by a plurality of sections of heating track within and along the length of the heating element 106, each section of heating track separately connected to the controller 134 and power supply 132 so as to be separately controlled for heating purposes.

The controller 134 can determine the position of the moveable base 108 along the axial length of the heating element 106. For example the controller 134 determines the position of the moveable base 108 along the guiding track, and from this can determine the corresponding position along the heating element 106. Based upon the determined position of the moveable base 108 along the heating element 106, the controller 134 can determine which heating zones are in the first region 136 of the chamber 102 (i.e. which heating zones form the first portion 150 of the heating element 106) and which heating zones are in the second region 138 of the chamber 102 (i.e. which heating zones for the second portion 152 of the heating element 106) to select a suitable heating profile.

Heating profiles correspond to the position of the relative position of the moveable base along the heating element; the heating profiles may be stored in memory accessible by the controller. That is, each heating profile corresponds to a different combination of heating zones in the first portion 150 of the heating element 106 and the second portion 152 of the heating element 106.

For the selected heating profile, the controller 134 controls the power to the heating element 106 such that the heating zones in the first region 136, that is the heating zones forming the first portion 150, are heated to first temperature (or supplied with a first power level) and the heating zones forming the second portion 152 are heated to a second temperature (or supplied with a second power level). The first temperature and the second temperature (or first power level and second power level) can be different. In this way, the first portion 150 of the heating element 106 can be heated to a different temperature to the second portion 152. This allows for the air to be pre-heated in the pre-heating region with the second portion 152 of the heating element 106 at a different temperature to the temperature of the first portion 150 of the heating element 106 used for aerosolisation. For example, it may be preferable to use a high or lower heating temperature for the pre-heated air, rather than the same temperature as that used for aerosolisation of the aerosol generating material.

In some examples, a user input can be used to set the desired temperatures for the first portion 150 of the heating element 106 (i.e. the aerosolisation temperature) and/or the second portion 152 of the heating element 106 (i.e. the pre-heating temperature).

In a further modification, the controller 134 can control the power to the heating element 106 such that heating zones within the second portion 152 of the heating element 106 are not heated (i.e. power is not supplied to them). In this way, the air is not pre-heated in the second region 138 of the chamber 102. In some examples, this can save battery power as power is only supplied to the first portion 150 of the heating element 106 needed for the aerosolisation of the aerosol generating material.

Whilst in the foregoing description, the moveable base 108 has been described as moveable with in the chamber 102, in an alternative such a base, which divides the chamber 102, may be instead fixed at a position within the chamber 102. That is, the features previously described with reference to the moveable base 108 may instead be incorporated into a fixed base, arranged along a length of the heating element 106, so as to divide the chamber 102 into the heating region 138 and a pre-heating region 138.

In the foregoing description, the aerosol generation medium 140 is described as a tobacco rod 140. In alternatives, other suitable types of aerosol generation medium 140 may be used. In an example, the aerosol generation medium 140 can be a cartridge comprising a liquid and/or solid aerosol generating material, as an alternative. The heating element 106 can be inserted into the cartridge and the through-holes 116 in the moveable base 108 can supply an airflow to the cartridge.

It will be readily understood that the features of any of the embodiments described herein can be readily combined with the features of any of the other embodiments described herein without falling outside of the scope of the present disclosure.

1. An aerosol generation device comprising:
a chamber with an opening for receiving an aerosol generation medium;
a heating element configured to heat the aerosol generation medium when the aerosol generation medium is received in the chamber;
a moveable base configured to move along a length of the chamber, wherein the moveable base comprises one or more channels configured to allow an airflow through the moveable base, and wherein the moveable base divides the chamber to define a first region positioned closer to the opening, and a second region positioned farther away from the opening; and
one or more air inlets arranged in the second region of the chamber, the one or more air inlets configured to provide an air flow path from outside the device into the second region by one or more air inlet channels connecting one or more air inlet openings adjacent to the opening of the chamber to the one or more air inlets in the second region of the chamber.

2. The aerosol generation device of claim 1, wherein the one or more air inlet channels run alongside the chamber to feed air into the second region of the chamber.

3. The aerosol generation device of claim 1, wherein the heating element extends into the chamber in a direction toward the opening.

4. The aerosol generation device of claim 1, wherein the first region is configured to heat the aerosol generation medium, and the second region is configured to pre-heat an airflow to the aerosol generation medium.

5. The aerosol generation device of claim 1, wherein the moveable base is configured to move along the heating element such that a first portion of the heating element is arranged in the first region of the chamber and a second portion of the heating element is arranged in the second region of the chamber.

6. The aerosol generation device of claim 5, wherein the heating element comprises a plurality of heating zones, each configured to be separately heated based upon a determined heating profile; and
wherein the aerosol generation device further comprises a controller configured to determine a position of the moveable base along the heating element, wherein the heating profile is determined based upon the determined position of the moveable base such that a first set of heating zones of the plurality of heating zones arranged in the first region of the chamber operate at a first temperature, and wherein a second set of heating zones of the plurality of heating zones arranged in the second region of the chamber operate at a second temperature different from the first temperature.

7. The aerosol generation device of claim 1, wherein the moveable base is moveable between an extended position at a first distance from the opening, and a retracted position at a second distance from the opening, the second distance being greater than the first distance.

8. The aerosol generation device of claim 1, wherein the heating element passes through an opening in the moveable base.

9. The aerosol generation device of claim 1, wherein the moveable base has a first surface facing toward the opening, and a second surface, opposite the first surface, facing away from the opening, and wherein the one or more channels pass through the moveable base to connect the first surface to the second surface.

10. The aerosol generation device of claim 1, wherein the heating element is a heating blade insertable into the aerosol generation medium when the aerosol generation medium is received in the chamber.

11. The aerosol generation device of claim 10, wherein the heating blade comprises a piercing end directed toward the opening of the chamber.

12. The aerosol generation device of claim 1, wherein the heating element is configured the heat the aerosol generation medium without burning the aerosol generation medium.

13. An aerosol generation system comprising the aerosol generation device of claim 1 with the aerosol generation medium received in the chamber.

14. The aerosol generation device of any claim 1, wherein the aerosol generation medium is a tobacco rod.

15. The aerosol generation system of claim 13, wherein the aerosol generation medium is a tobacco rod.
